(19) United States
(12) Patent Application Publication
(10) Pub. No.: US 2010/0147871 A1
(43) Pub. Date: Jun. 17, 2010

(54) Container Arrangement

(76) Inventors: Alfred Haas, Ettingen (CH); Martin A. Bühler, Basel (CH)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 12/527,839

(22) PCT Filed: Feb. 15, 2008
(86) PCT No.: PCT/EP2008/001179

§ 371 Date: Dec. 8, 2009

(30) Foreign Application Priority Data
Feb. 19, 2007 (CH) CH 00274/07

(51) Int. Cl. B67D 7/00; B65D 25/04

(52) U.S. Cl. 222/1; 220/500; 222/95; 222/105; 222/386.5; 222/389

(57) ABSTRACT

The invention relates to a container arrangement for fluids that contain gas, comprising a casing. Said casing is made of a pressure-proof collapsible material, and surrounds at least two chambers. The first chamber is used to receive and release the fluids containing gas via a first connection. The second chamber is a pressure chamber that is provided with a second connection for applying pressure. A flexible wall is arranged between the first chamber and the second chamber. The invention further relates to a method for transporting and releasing liquids containing gas into or from a pressure-proof collapsible casing, in addition to a corresponding pressure-proof, flexible non or slightly elastic covering. A container arrangement for liquids containing gas that has a simple construction, is easy to produce, fill, transport, empty and dispose of or recycle is provided due to the above mentioned invention.

The invention relates to a container arrangement for liquids which contain gas, preferably for drinks, comprising a casing or shell, and to a method of transporting and dispensing liquids, which contain gas, into and out of the pressure-proof, collapsible casing, and to a shell.

Soft-walled liquid containers consisting of different materials and in different forms are widely used. The term “soft-walled” is intended to refer to all container materials, by which no rigidly defined shape is specified, such as e.g. synthetic material films, flexible composite materials or woven materials. In comparison with hard-walled containers, they have the advantage that they are only intended for single usage and are disposed of or recycled after usage. This eliminates any costs associated with the return transportation and cleaning of the receptacles.

However, the currently widely used flexible synthetic material bags for packing liquids and other products have the disadvantage that they are not suitable for the storage and transportation of products subjected to pressure, e.g. liquids which contain CO2, such as e.g. beer or mineral water. Even a small amount of internal pressure expands the bag or even causes it to burst apart.

Furthermore, a container in which the internal pressure is lost as a result of its flexible outer wall yielding during removal of the product is not suitable in particular for liquids which contain gas, since a constant internal pressure is required for uniformly dispensing and completely emptying the container.

Preferably hard-walled containers have hitherto been used for the storage and transportation of liquids which contain a gas such as e.g. CO₂. In particular, where large quantities are concerned, drinks suppliers use the typical containers which are defined by the term “keg” or “keg barrel” and are made from of high-grade steel or even from synthetic material, such as e.g. PET.

Barrels made from high-grade steel are used in particular on account of their mechanical robustness, as the pressure which builds up in the container by reason of the CO₂ content, can be over 6 bar and must be absorbed by the container. The extent of the pressure build-up is related to the CO₂ content itself, the temperature and the movement (shaking) of the product. It cannot be reliably guaranteed that the known soft-walled containers are able to absorb such high pressure. On the other hand, the internal pressure is required for drawing individual quantities of the liquid and in general is kept constantly high by virtue of additional pressurisation.

In the case of the “keg barrels” it is also disadvantageous that e.g. the price of steel has increased dramatically in recent years, which is naturally also reflected in the prices for a “keg barrel”. Furthermore, steel is relatively heavy, in particular in comparison with synthetic material, so that e.g. an empty 20 Litre “keg barrel” already weighs about 5 kg on its own.

Furthermore, since the drinks are delivered from a “keg barrel” by means of carbon dioxide, the CO₂ as a delivery medium comes into direct contact with the drink which after a few days results in carbonisation of the drink and thus has a particularly adverse effect upon the quality of the drink.

Since the “keg barrels” have the same external dimensions in the full or emptied state, they take up an unnecessarily large volume particularly during return transportation for recycling, for which reason the storage and transportation of the barrels is very cumbersome and cost-intensive.

Furthermore, it is necessary to use a large amount of chemicals and energy in order to clean the used “keg barrels” and to provide them once more for reuse.

Accordingly, the object of the invention is to provide a container arrangement for liquids which contain gas, which has a simple construction and is easy to produce, fill, transport, empty and to dispose of or recycle.

This object is protected by the features of the independent claims. The dependent claims develop the central idea of the invention in a particularly advantageous manner.

In accordance with the invention, the container arrangement for liquids which contain gas comprises a casing consisting of a pressure-proof, collapsible material. The casing surrounds at least two chambers, wherein the first chamber serves to receive and dispense the liquid, which contains gas, via a first connection, and the second chamber is a pressure chamber which is provided with a second connection for the application of pressure. Disposed between the first chamber and the second chamber is a flexible wall.

By virtue of the fact that the two chambers are surrounded by a pressure-proof, collapsible casing, on the whole there is no or only a small volume expansion of e.g. 1 to 3%. By virtue of the fact that the second chamber is pressurised via the second connection, the first chamber is pressurised to a pressure required for drawing or emptying the gas-containing liquid from the first connection by reason of the flexible wall disposed between the chambers, and the volume of the first chamber is thus continuously reduced as a result of the emptying procedure. Since the pressure which is generated in the second chamber is absorbed by the pressure-proof casing, it is inevitably guided via the flexible wall to the first container and pressurises the liquid located therein to the required dispensing pressure, so that when the first connection is open the gas-containing liquid can be removed at constant pressure by reason of the pressurisation and volume expansion of the second chamber and the consequential volume reduction of the first chamber.

It is thus possible to fill gas-containing liquids, such as carbon dioxide-containing drinks, into a flexible pressure-proof and collapsible non-returnable package.

By reason of the structure of the container arrangement, it is also possible to empty the container arrangement so that it is virtually residue-free, since a pressure is exerted continuously via the wall upon the first chamber from the second chamber with sustained pressurisation, until the second chamber takes up the entire volume of the casing and thus also reduces the volume of the first chamber to a minimum. Therefore, it is also the case that during emptying of the container arrangement no product is lost or only a small amount of product is lost in comparison with known container arrangements.

The container arrangement also weighs a great deal less than barrels (e.g. about 90% lighter than comparable “keg barrels” or even wooden barrels) which are used for comparable liquid quantities. Moreover, no cleaning, return transportation and additional storage costs are incurred, as the container arrangement can be simply disposed off or even recycled. Therefore, the container arrangement is also environmentally friendly because it is not necessary either to use chemical cleaning agents or to use energy for transportation and storage and moreover this bag can be sent in an ecological manner for recycling or can otherwise be disposed of in an environmentally compliant manner, e.g. burned in an environmentally compliant manner.

Furthermore, the container arrangement dispenses with the use of steel, so that it can also be produced relatively cost-effectively and with low-energy requirements at least partially by means of already known methods and on already existing machines.

In addition, this type of container arrangement particularly when empty is very flat and space-saving, above all in comparison with barrels which take up the same spatial volume when in the full or empty state. The storage volume can thus be reduced e.g. by about twenty times, so that storage costs can also be reduced considerably. Moreover, by virtue of the fact that the container arrangement in accordance with the invention is relatively light and small it is also much easier to handle.

It is also advantageous that no demands, in particular in relation to hygiene, are placed upon the delivery medium which for the application of pressure is guided into the second chamber, as the delivery medium is introduced into a chamber which is spatially separated (by means of the wall or a membrane) from the gas-containing liquid. Therefore, in addition to CO₂ it is also possible to use e.g. compressed air or (mains) water for the application of pressure. However, the use of a food-safe delivery medium is not required.

However, since CO₂ does not come into direct contact with the gas-containing liquid even when it is used as the delivery medium, it also cannot lead to carbonisation of the liquid, which in turn has a positive effect upon the quality of the product and its storage life. The natural gas content (e.g. CO₂ content) of the product is retained even after the product is removed from the container arrangement for the first time, whereby the product characteristics, such as e.g. the flavour, are maintained unchanged.

In accordance with a first preferred embodiment of the invention, the second chamber can surround the first chamber completely, wherein the wall is formed preferably by means of a sheath of the first chamber. In an advantageous manner, the casing is formed from a pressure-proof outer wall of the second chamber.

In accordance with a second preferred embodiment, the first chamber and the second chamber can be disposed next to one another in the casing.

Preferably, the first chamber and the second chamber are formed as separate soft-walled bags or containers. The wall is formed advantageously from the adjoining wall regions of the first and the second chamber.

It is also feasible that the first chamber and the second chamber are formed from a single bag or container, wherein the wall is formed preferably integrally with the bag or container between the chambers. For example, the pressure-proof casing can surround the bag or container completely. However, it is also feasible that the bag forms the pressure-proof casing; in this case the wall can thus be disposed in the casing such that it separates the casing into the first chamber and the second chamber.

In a particularly preferred embodiment, the container arrangement preferably has a pad shape and preferably also handles. However, the container arrangement can also take any other shape, such as e.g. a cylindrical shape or cubic shape.

The embodiment of the container arrangement as a bag, in particular in the shape of a pad, renders it possible to handle the container arrangement easily. It is thus also possible to transport the container arrangement easily, as in the shape of a pad they can be loaded e.g. conveniently onto Euro pallets either with corresponding frames or by means of a package, such as e.g. a light cardboard package which can be stacked effectively.

A further aspect of the invention describes the pressure-proof flexible shell or casing which cannot expand or can only expand to a slight extent and which is used in particular in the container arrangement in accordance with the invention. The shell consists of a film which is reinforced by means of mineral or synthetic fibres in the longitudinal or transverse direction or in the longitudinal and transverse direction or consists of a woven material which is produced from synthetic or mineral fibres or is reinforced by fibres of this type.

Preferably, this pressure-proof flexible shell which cannot expand or can only expand to a slight extent can surround in principle all soft-walled, non-pressure-proof bags or containers, such as e.g. the inventive product bags or pressure bags, such that they become pressure-proof.

This affords the advantage that these soft-walled bags or containers can be used e.g. for the storage and transportation of gas-containing liquids, which contain e.g. CO₂, such as beer or mineral water, and must therefore be pressure-proof.

As already explained above, the shell can also preferably be a separate or integral part of the bag or container made pressure-proof in this way.

In a particularly preferred manner, the shell is joined together by means of self-adhesive film or self-adhesive woven material or by gluing or welding.

In a preferred manner, it is also possible to optimise the fibre reinforcement of the film or the structure or the reinforcement of the woven material by specific local adaptation of the fibre density per unit of area. In this manner, it is also possible to reduce the cost and weight of the container arrangement.

With a shell formed in this manner, it is possible to absorb the high tensile forces which are generated by the internal pressure of a gas-containing liquid. Furthermore, the shell is flexible so as to be able to adapt to the geometric shape of the inner bag or product and/or pressure bag.

Further features, advantages and characteristics of the invention will now be explained with reference to exemplified embodiments and the Figures of the accompany drawing, in which

FIG. 1 shows a schematic illustration of an empty container arrangement in accordance with a first embodiment,

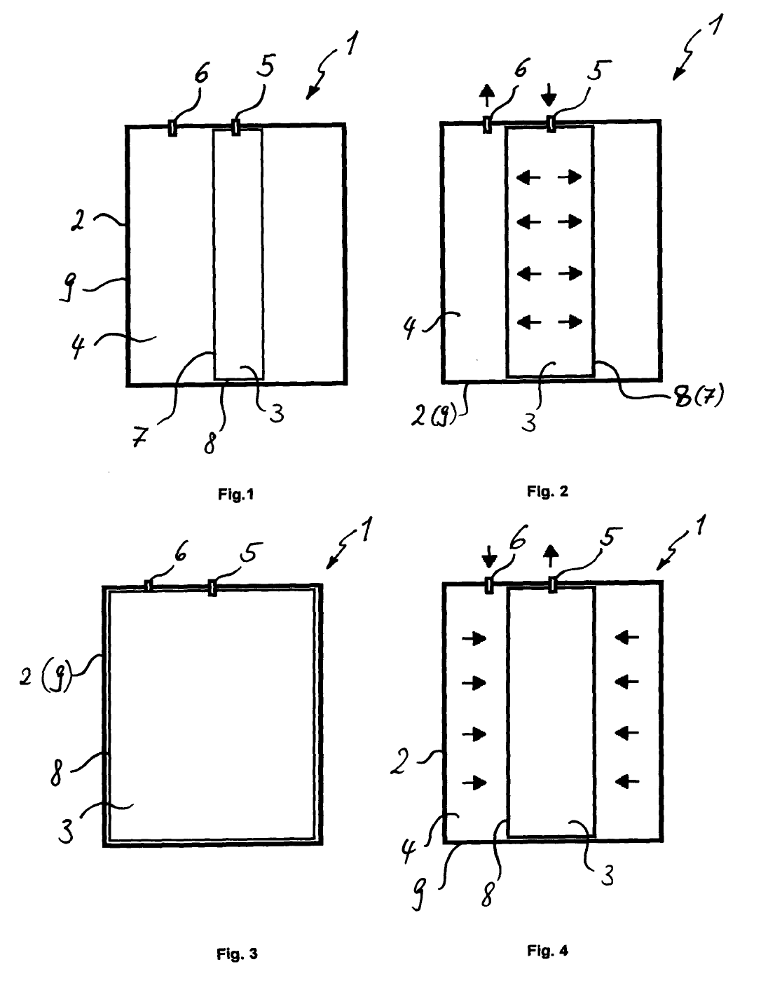

FIG. 2 shows the container arrangement of FIG. 1 during filling,

FIG. 3 shows the container arrangement of FIG. 1 in the full state,

FIG. 4 shows the container arrangement of FIG. 1 during emptying,

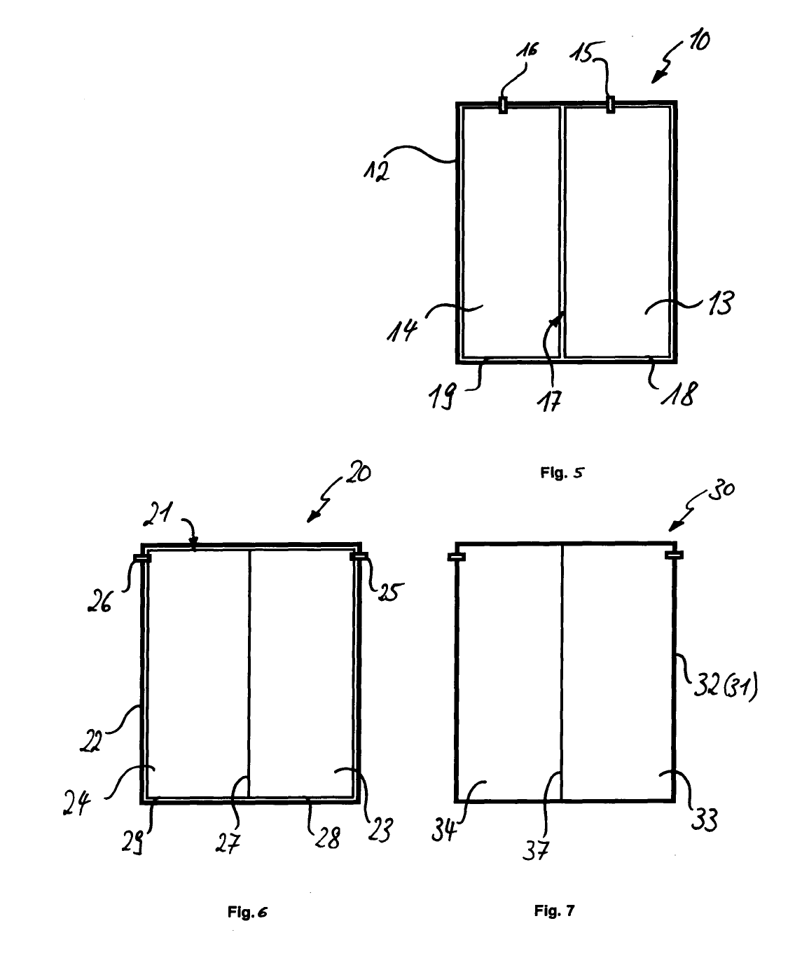

FIGS. 5-7 show schematic illustrations of various embodiments of a container arrangement in accordance with a second embodiment,

FIGS. 8-12 show schematic illustrations of various container and connection forms,

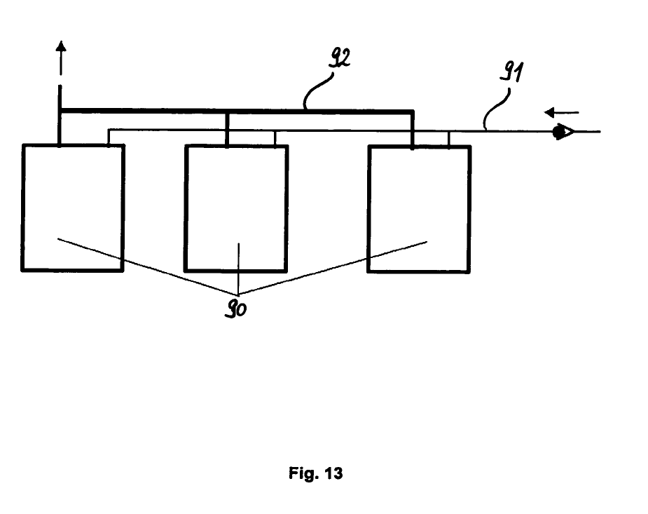

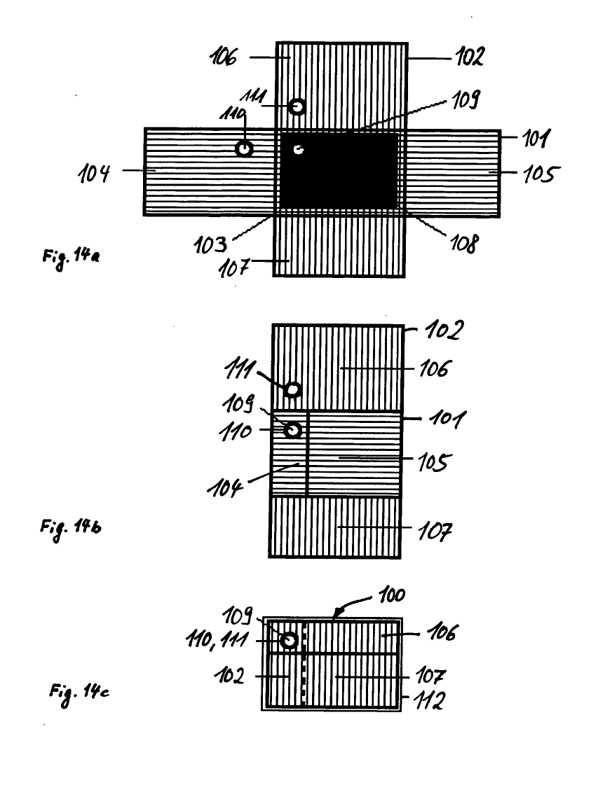

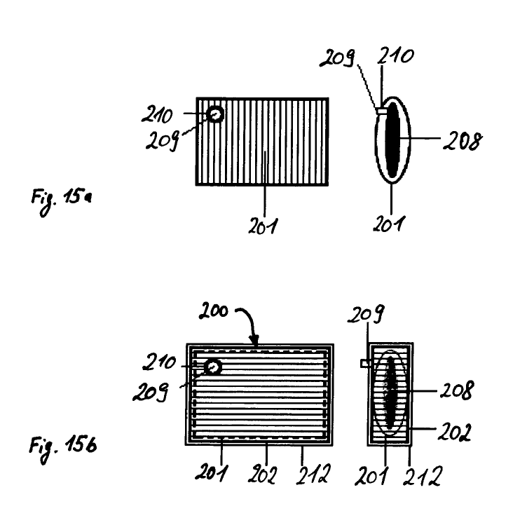

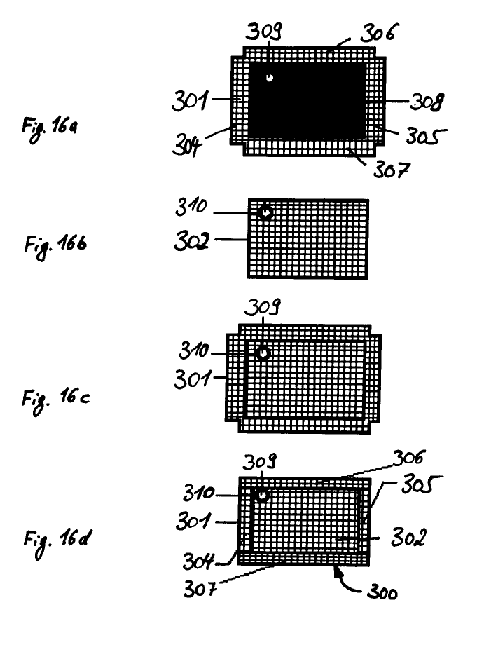

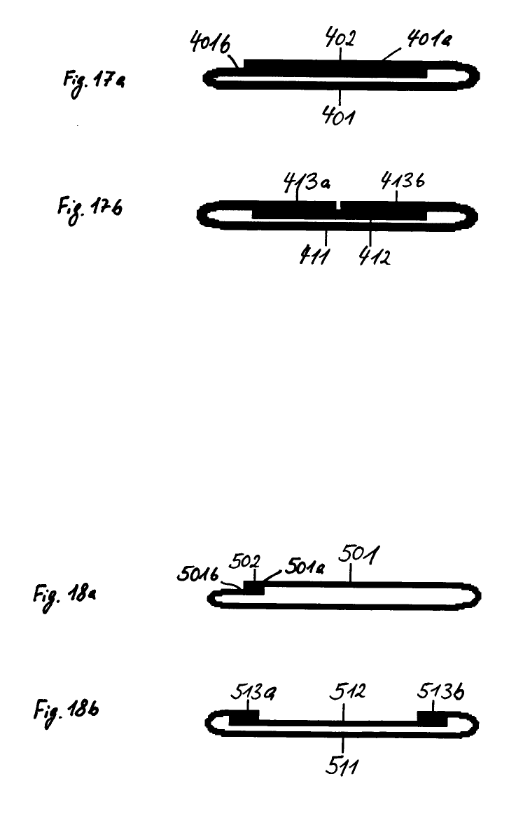

FIG. 13 shows an arrangement of several container arrangements connected in parallel,

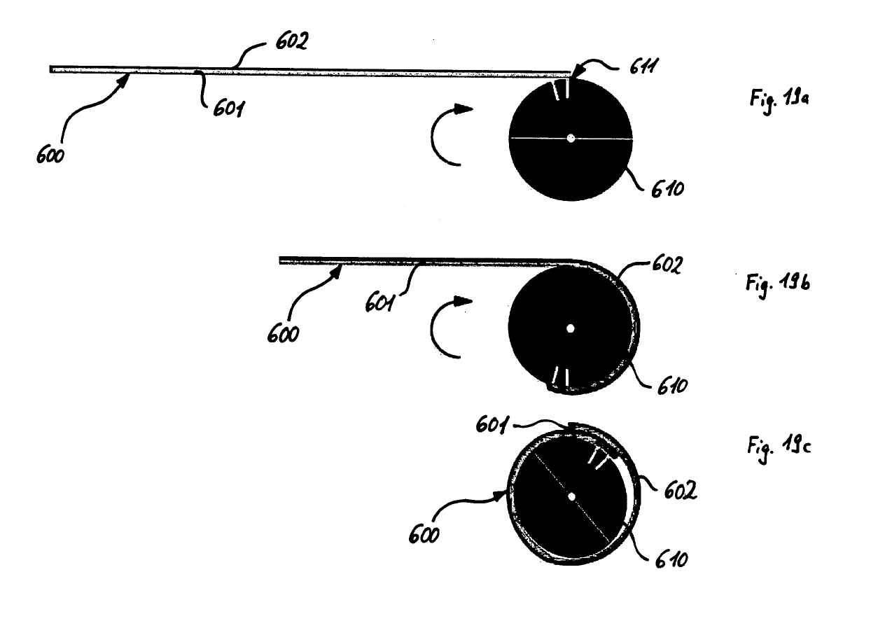

FIGS. 14a-14c show a schematic illustration of a shell consisting of isotropic, fibre-reinforced synthetic material film with a self-adhesive connection or a connection established by gluing,

FIGS. 15a-15b show a schematic illustration of a shell consisting of two individual, tubular parts of isotropic synthetic material film surrounded by a shrink film or a welded protective film,

FIGS. 16a-16d show a schematic illustration of a shell consisting of woven fabric,

FIGS. 17a-17b show an illustration of various ways of joining together the shell by means of self-adhesive fibre-reinforced film or woven fabric or by means of glue or welding applied at various adhesion sites,

FIGS. 18a-18b show an illustration of various ways of joining together the shell by means of adhesive or welding,

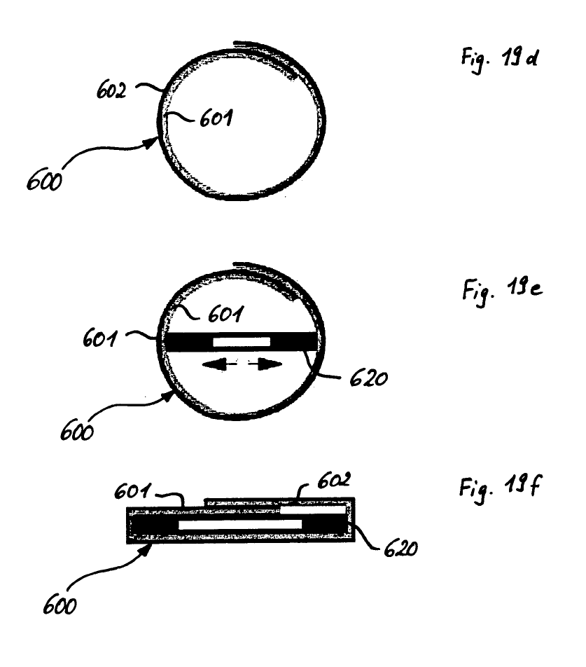

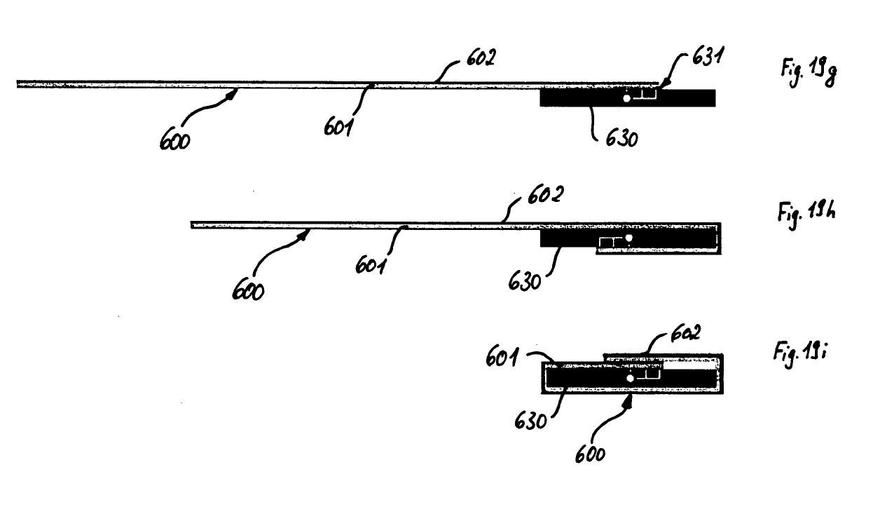

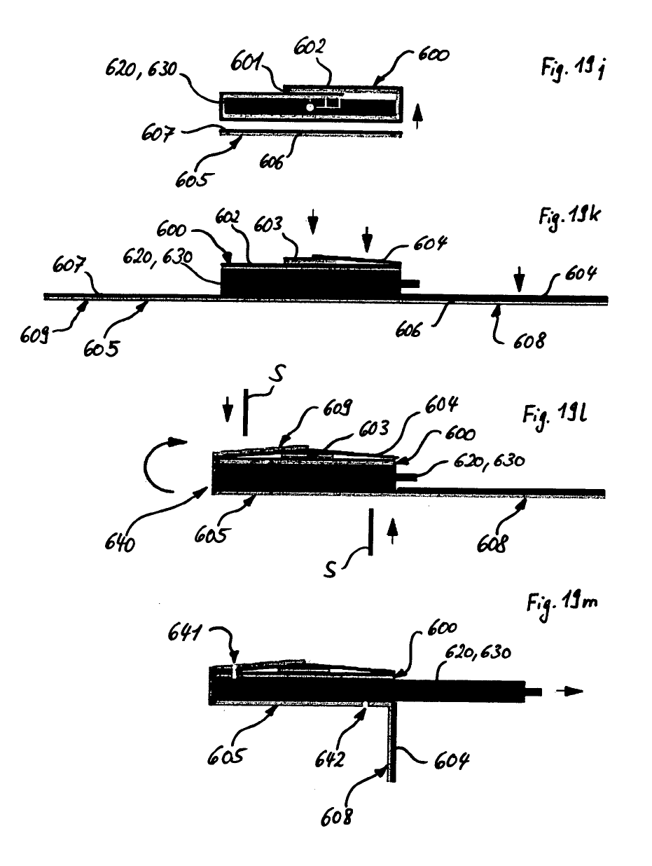

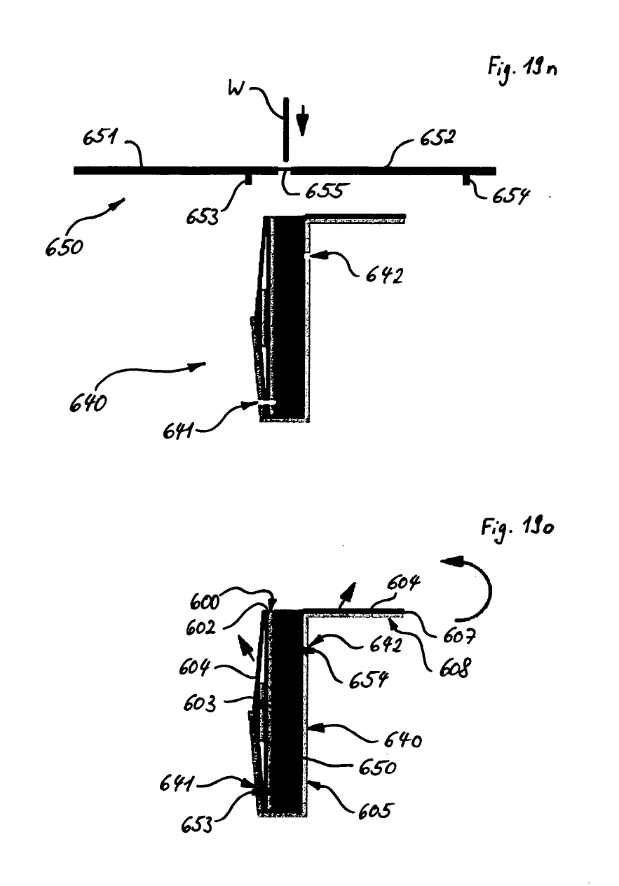

FIGS. 19a-19o show methods of joining together a bag in accordance with the invention.

FIG. 1 illustrates a container arrangement 1 in accordance with the invention. This container arrangement 1 is used preferably to receive, transport and dispense liquids, in particular gas-containing liquids. In a particularly preferred manner, the liquids or the product are drinks such as e.g. beer, mineral water or even sparkling wine.

It should be pointed out at this juncture that the invention also covers receiving and dispensing all other conceivable liquids. This also includes in particular but not exclusively viscous media, such as e.g. glue, paint, sauces or the like.

The container arrangement has a shell 2 which is also referred to hereinafter as a casing which consists preferably of a pressure-proof, collapsible material. The casing 2 is on the one hand flexible but on the other hand is non-expandable or only slightly expandable, so that it is able to absorb high internal pressures between 2 and 10 bar, preferably at least up to 6 bar. The terms “pressure-proof”, “flexible”, “non-expandable or only slightly expandable” are intended for the purpose of this description to refer to all shells 2, by which no rigidly defined shape is specified, which thus consist of woven material, synthetic material films, flexible composite materials, composite films, self-adhesive films, fibre-reinforced films or others, in particular the materials stated in the description which possess the said characteristics.

The shell 2 preferably surrounds at least two chambers 3, 4.

The first chamber 3 is used to receive the product which is to be stored or transported, i.e. preferably the gas-containing liquid. The chamber 3 is connected to the area surrounding the container arrangement by means of a first connection 5 which is also referred to hereinafter as a product connection. The product connection 5 is preferably formed with a non-return valve or other valve typically used e.g. in beverage dispensing units. The connection 5 renders it possible to introduce the product into the first chamber and the product connection 5 can then also be used to dispense the product from the first chamber 3.

The second chamber 4 is a pressure chamber preferably which is provided with a second connection 6 for the application of pressure. The second chamber 4 is used to receive a delivery medium, which is pressurised, via a connection 6 which is also referred to hereinafter as a pressure connection. In principle, the medium used can be any liquid, e.g. CO₂, compressed air or water. The connection 6 can be formed e.g. in the same manner as the first connection 5.

Preferably, a flexible wall 7 is disposed between the first chamber 3 and the second chamber 4.

As shown in the first embodiment in FIG. 1, the wall 7 of the container arrangement 1 can consist of the sheath of an inner product bag 8, wherein the product bag 8 surrounds the first chamber 3. The product bag 8 thus receives the product via the first connection 5 which extends through the casing 2. The product bag 8 is preferably flexible and is produced from a food-safe synthetic material. It does not have to be pressure-resistant.

In this first exemplified embodiment, the casing 2 is formed in a particularly preferred manner from a pressure-proof outer wall of the second chamber 4 and thus constitutes an outer pressure bag 9. The pressure bag 9 surrounds the product bag 8 completely and hermetically seals it, so that consequently the second chamber 4 surrounds the first chamber 3 completely. This product bag 9 consists preferably of a gas-tight film which can also absorb the mechanical loading caused by the pressure. However, as also illustrated in further embodiments, the casing or shell 2 as a separate part can surround the non-pressure-proof inner bags or containers or can even be an integral part thereof. The construction and production of this type of film or bag will be described in more detail at a later point in the description.

The advantages of this construction reside in its simple production, in particular of the bags, with currently used bag production machines without any significant modifications. It is also cost-effective as only two bags have to be produced, and is readily possible in the form of “continuous bags” for currently typical bottling facilities. The bags are also preferably produced from recyclable and/or environmentally compliant materials, so that they can be recycled or disposed of in a simple, cost-effective and environmentally friendly manner

Furthermore, considerable cost savings can be achieved in logistics, as no return-transportation of the container arrangement is required, since after use they can be disposed of in a simple and space-saving manner on account of their collapsible construction and the emptied containers are thus also not cleaned.

A further significant advantage of the invention resides in the fact that there is no contact between the delivery medium and the product, so that the requirements placed upon the hygiene of the delivery medium are very small, which permits the use of numerous and also cheaper delivery media, such as e.g. water or compressed air. However, even when CO₂ is used as the delivery medium, it cannot lead to carbonisation owing to the lack of contact with the product. In this manner, e.g. the natural gas content (e.g. CO₂ content) of the product is retained even after the product is removed from the container arrangement for the first time, and consequently the flavour and also the quality of the product are also retained. Therefore, the product also remains fresh for a longer period of time, particularly when it is in the “tapped” state.

In particular, viscous media, such as e.g. glue, paint or sauce, are typically filled into rigid containers and must then be pumped out of the container in order to be used.

This is difficult particularly in the case of viscous media or even impossible in the case of media which harden. The container arrangement in accordance with the invention ensures that the product can be expelled from the container arrangement using any delivery medium, such as e.g. compressed air, wherein the aforementioned pump can be dispensed with. Since on the other hand the delivery medium does not come into contact with the product and also no air or the like can penetrate into the product bag, the product also cannot harden.

A filling and emptying procedure of the container arrangement 1 will be described hereinafter with reference to FIGS. 1 to 4.

As already described in detail, the container arrangement in accordance with the first exemplified embodiment consists preferably of mutually independent bags 8, 9 or chambers 3, 4. The product bag 2 which in FIG. 1 is still empty is used to receive the product, which is to be stored or transported, via the product connection 5. The product bag 1 is used to receive the pressurised delivery medium via the pressure connection 6. For filling purposes, the connections 5, 6 of the container arrangement 1 are preferably connected to a corresponding pressure line or product line of a bottling facility.

In order to be able to use the first chamber 3 completely for introducing the product, preferably the product bag 8 is subjected to a vacuum prior to the filling procedure. In this manner, the residual oxygen located in the product bag 8 can be completely removed therefrom. The vacuum can be introduced on the one hand by drawing the air out of the first chamber 3 via the product connection 5. Preferably, the same effect, i.e. the elimination of the residual oxygen in the product bag 8, can also be achieved by the pressurisation of the pressure chamber 4 with a defined primary pressure. By virtue of the overpressure thus achieved in the pressure chamber 4, the product bag 8 is consequently compressed and the remaining residual oxygen is thus pressed out of the bag. It is then possible to commence the filling procedure described hereinafter.

FIG. 2 illustrates a filling procedure of the container arrangement 1. For this purpose, the container arrangement 1 can be filled by conventional bottling facilities. This and the preceding and subsequent steps can preferably also be performed in a partially or fully automated manner, in order to be able to provide numerous container arrangements 1 in a short period of time.

During the illustrated filling procedure, the product bag 8 is filled with the product via the product connection 5 and consequently expands inside the pressure-proof casing 2. By reason of the volume expansion of the product bag 8 or of the first chamber 3, an existing gas volume or fluid volume in the pressure bag 1 is evacuated or discharged via the pressure connection 6 by reason of the volume reduction in the second chamber 4.

In an advantageous manner, filling of the container arrangement 1, i.e. filling of the product bag 8, is effected against a specific counter pressure which is generated preferably by the pressurisation in the pressure bag 9. This prevents the formation of foam during the filling procedure. The pressure required for this purpose is preferably about 2.5 bar, but is not restricted to this.

After the product bag 8 is completely filled with the product, as shown in FIG. 3, the connections 5, 6 are preferably separated from the lines of the bottling facility and at least the product bag 8 is closed in a sealed manner at the product connection 5. This can be achieved preferably by means of a non-return valve present in the connection or by the insertion of a simple plug, a plug with a fixedly connected hose, of a tap or another valve or closure. The container arrangement filled in this manner can then be stored and transported with or without additional packaging. An overpressure which is generated possibly by virtue of the gas-containing product during storage and transportation, is absorbed by the construction of the container arrangement 1. The outer pressure bag 9 which is formed by the casing 2 functions as a pressure shell.

FIG. 4 illustrates the procedure of emptying the container arrangement 1. The product connection 5 of the first chamber 3 is then connected to a product line of a dispensing system or beverage dispensing unit. The pressure connection 6 of the second chamber 4 is connected to a pressure system, such as e.g. a compressor, a gas bottle or a water pipe. The container arrangement can be connected e.g. to existing dispensing systems without any further or significant modifications, whereby the container arrangement 1 can be used conventionally almost without limitation in catering, but also for private use.

In order to ensure adequate cooling of the product, the container arrangement 1 can preferably be placed in a chill room or in a special cooling box. Again, this can be done with or without additional packaging. It is also feasible that the container arrangement 1 is connected in a known manner to a through-flow cooler. After the product connection 5 and the pressure connection 6 are thus connected to a dispensing system as described above (optionally in the chill room/cooling box or with an interconnected through-flow cooler), the container arrangement 1 is ready to be emptied.

For this purpose, the pressure bag 9 is subjected to a pressure, the so-called delivery pressure, via the second connection 6. This pressure can be generated by means of a fluid medium, such as e.g. a gas, e.g. CO₂ or compressed air, or a liquid, e.g. water. By reason of this pressurisation, a pressure is exerted onto the product bag 2 via the wall, i.e. the sheath of the product bag 8. The product bag 8 is consequently emptied through the product connection 5. It is likewise possible to have a mechanical pressure exerted upon the product bag 8 to empty same.

The delivery pressure in dispensing systems is e.g. about 2 to 3 bar which in the case of the container arrangement 1 is achieved by means of a specific pressure shell or casing of the inner bag(s). The special film used for this purpose which at the same time is pressure-proof, demonstrates no or minimal expansion and is also flexible and collapsible, and the production thereof will be described in detail at a later point in the description.

After the container arrangement 1 is empty, it is removed and replaced, folded up and disposed of or recycled. This is achieved by virtue of the fact that the container arrangement is considerably lighter in weight than comparable conventional barrels. Owing to the fact that it is possible to dispose of the container arrangement in a space-saving manner on site, costs for the return transportation of a container arrangement and any further unnecessary storage costs are also obviated. Furthermore, cleaning costs and the use of chemical cleaning agents are also avoided, so that by reason of the lower transport costs and thus lower energy expenditure the container arrangement is significantly more environmentally friendly than the hitherto known barrels or container arrangements. This is further abetted by virtue of the fact that during the production of the container arrangement 1 the use of steel is omitted completely or as far as possible. The container arrangement 1 can thus be produced more cheaply and with less energy and can also be handled more easily because it weighs less than conventional barrels. Furthermore, the container arrangement can also be sent for recycling without any problem.

Furthermore, FIGS. 5 to 7 illustrate various designs of a container arrangement in accordance with a second embodiment, in which the chambers 13, 14 do not surround one another but are preferably disposed next to one another.

In the case of the first embodiment illustrated in FIG. 5, the chambers 13, 14 of the container arrangement 10 are formed from two mutually independent bags 18, 19 which are surrounded by a pressure-proof shell or casing 12. The bags 18, 19 are disposed in the casing in such a manner, so that the wall 17 is formed from adjoining wall regions of the first chamber 13 and of the second chamber 14. The product bag 18 comprises a product connection 15 and the pressure bag 19 comprises a pressure connection 16, like the connections 5, 6 of the first embodiment.

In the case of this construction, two conventional, preferably identical bags can be used as the product bag 18 and pressure bag 19. The bags 18, 19 are preferably flexible and at least the product bag 18 is produced from a food-safe synthetic material. The bags 18, 19 do not have to be pressure-resistant.

Preferably, the bags 18, 19 in the filled state can each fill the inner volume of the casing 12 completely. This ensures that on the one hand the product bag 18 can receive the maximum volume of the container arrangement 10 during filling and on the other hand the pressure bag 19 can likewise fill the maximum inner volume of the casing during emptying, so as to be able to ensure that the product bag 18 and product chamber 13 are emptied completely.

The surrounding pressure shell 12 can consist preferably of a synthetic material film, flexible composite film, woven material or the like. In a particularly preferred manner, the pressure shell comprises fibre-reinforced films, in order to be able to capture and absorb the mechanical pressure loading in a particularly effective manner. The pressure shell 12 can also be gas-tight. The materials both of the pressure shell and of the bags will be discussed in more detail at a later point in the description.

In the case of the second embodiment of a container arrangement 20 illustrated in FIG. 6, the product bag 28 and the pressure bag 29 are formed preferably from a single soft-walled pressure container or bag 21, or are combined to form a single bag 21 having two chambers 23, 24. The wall 27 is formed integrally with the bag 21 between the chambers 23, 24 and constitutes the separation region between the two chambers 23, 24. The bag 21 is surrounded by a pressure-proof casing or shell 22. The bag 28, 29 and shell 22 have the same materials and characteristics as the bags 18, 19 and the shell 12 of the first embodiment. Equally, they each have a corresponding connection 25, 26.

In a preferred manner, the chambers 23, 24 each have at least the same inner volume as the shell 22, in order on the one hand, as already explained above, to utilise the fill volume of the container arrangement 20 to the maximum extent and on the other hand to ensure that the product bag 28 or the product chamber 23 is emptied completely. It is also feasible that in the empty state the chambers 23, 24 are formed slightly smaller than the shell 22 and the chambers 23, 24 expand in the filled state such that they adapt to the shell 22 in terms of size and shape.

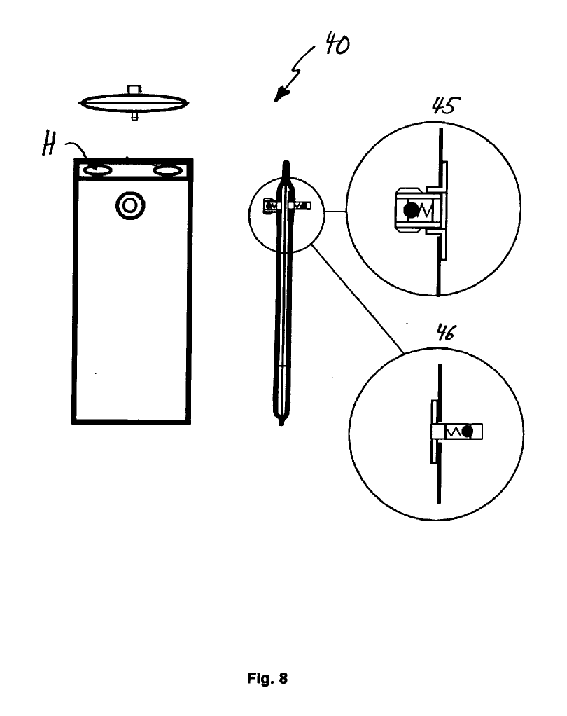

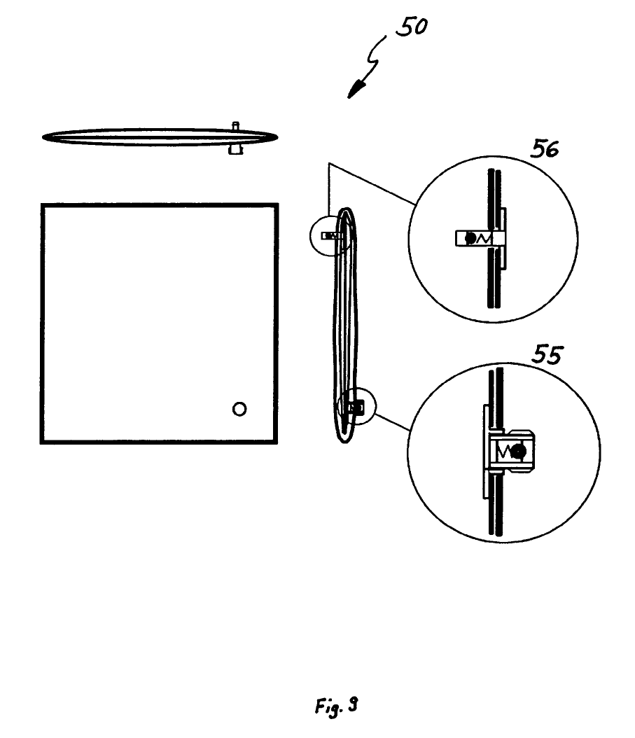

A third embodiment of a container arrangement 30 illustrated in FIG. 7 consists of a bag 31 which is divided in the centre by means of a wall or film 37 into two chambers 33, 34. The bag 31 thus forms the pressure-proof casing 32, so that consequently the wall 37 is disposed in the casing 32 in such a manner that it separates the casing 32 into the first chamber 33 and the second chamber 34. The bag 31 and/or the casing 32 consists on the outside of a gas-tight, pressure-proof film like the casing 2 of the first exemplified embodiment and is thus pressure-resistant in its own right. The film 37 is preferably flexible and is produced from a food-safe synthetic material. It does not have to be pressure-resistant but preferably must be gas-tight.

This bag 32 can be produced e.g. in one operation in a simple and cost-effective manner from three film layers. This can be carried out at least partially, preferably even by means of already known methods and on already existing machines. It is also readily possible to produce continuous bags for currently conventional bottling facilities. This will be described in more detail hereinafter.

FIGS. 8 to 11 illustrate various preferred container forms and various preferred connection forms of a container arrangement in accordance with the invention. In each case, the Figures always show the following: at the top a plan view of the container arrangement, at the bottom a front view thereof and next to it on the left-hand side a side view of the container arrangement. In the Figures, like features are designated by like reference numerals and in relation to these features reference is made to the above embodiments. Above and beyond the illustrated preferred examples, the shape of the bags is substantially freely selectable.

FIG. 8 illustrates a container arrangement 40 in accordance with the third design of the second embodiment which is in the shape of a pad. A container shape of this type renders it possible to store and transport the container arrangement in a convenient manner, as in the shape of pad they can be loaded e.g. conveniently onto Euro pallets either with corresponding frames or by means of light additional packaging, such as e.g. a cardboard package or cardboard box which can be stacked effectively.

The container arrangement in the shape of a pad can thus also be handled effectively, which can also be improved still further by means of handles H which are preferably integrally formed in the container arrangement. For example, a 20 litre container arrangement weighs in the filled state about 5 kg less than a comparable “keg barrel” and also has, in comparison with steel, a soft body so that handling and also ease of handling are considerably improved. It is also feasible e.g. that the additional packaging is formed in such a manner that the handles H can be grasped from the outside, in order to improve handling of packaged container arrangements still further.

FIG. 9 illustrates a container arrangement 50 likewise in the shape of a pad in accordance with the second design of the second embodiment.

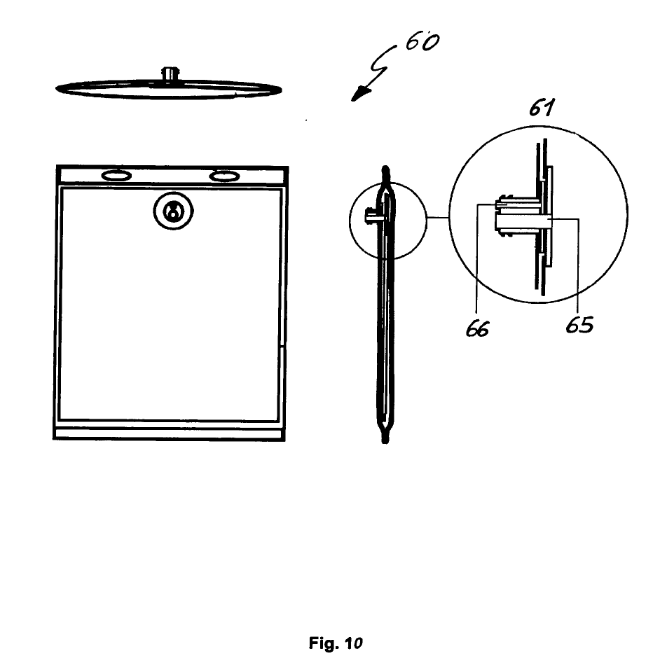

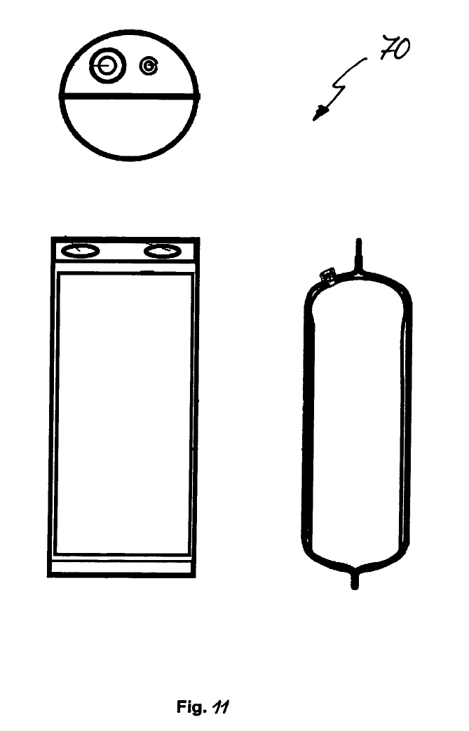

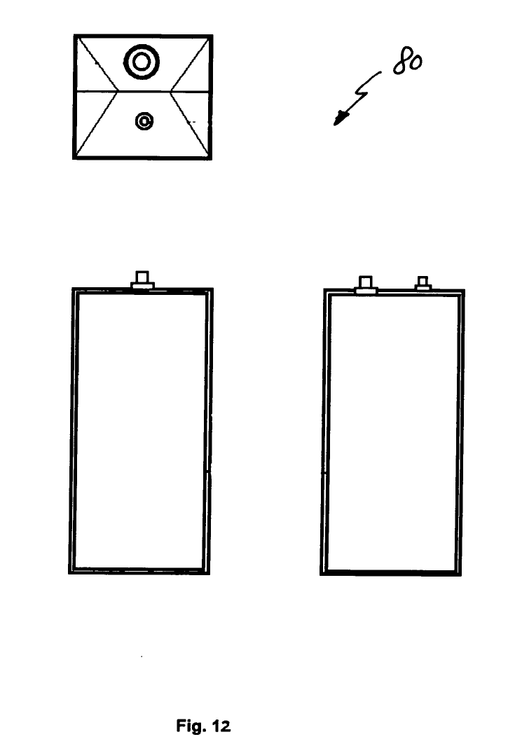

FIG. 10 illustrates a container arrangement 60 in accordance with the first embodiment which also has the shape of a pad with handles H.

FIG. 11 illustrates a container arrangement 70 in accordance with the first embodiment which has a cylindrical shape and also handles H.

FIG. 12 illustrates a container arrangement 80 likewise in accordance with the first embodiment which has a cubic shape.

For these embodiments, the connections, i.e. the product connection and the pressure connection, can be formed for the product chamber and pressure chamber either, as shown in FIG. 8 or 9, separately (product connection 45, 55; pressure connection 46, 56) or, as shown in FIG. 10, in a combined form as a combined connection 61 with an integrated product connection 65 and pressure connection 66.

Furthermore, the container arrangement in accordance with the invention can be formed in different sizes. It can be formed e.g. with a capacity of 5 litres for private usage instead of the known so-called party-containers, or else in sizes of 15, 20, 25, 30 or 50 litres which are typical for “keg barrels”. However, the invention is not limited to the said sizes, so that the capacity can be established as required.

However, in order on the one hand to improve or simplify handling, transportation and storage of the container arrangement and on the other hand to increase an available product quantity as required, several container arrangements can also be interconnected, i.e. connected in parallel. This is schematically illustrated in FIG. 13. For this purpose, the pressure connections of the container arrangements 90 to be connected in parallel are connected to a pressure line 91. On the other side, the product connections of the said container arrangements 90 are connected to a product line 92. In this manner, any number of container arrangements can be connected in parallel.

Furthermore, it is also feasible that several container arrangements are connected in each case independently of each other to a dedicated pressure line, but to the same product line. Furthermore, it is also possible that several container arrangements are connected to a pressure line, but in each case individually or in groups to several product lines. In accordance with the invention, the possible connections are not limited.

In order to obtain a pressure-proof, collapsible container arrangement 1, 10, 20, 30, 40, 50, 60, 70, 80, 90 or casing or shell 2, 12, 22, 32 at all, it is necessary to use specific materials and production methods which are described hereinafter.

The arrangement illustrated in FIG. 14a consists preferably of at least two substantially rectangular, fibre-reinforced isotropic films 101, 102, from which the casing or shell 100 is formed. The films 101, 102 are preferably films which are self-adhesive on one side or films which are adhered by the application of glue. The films 101, 102 are disposed preferably crosswise, and particularly preferably are disposed at a substantially right angle with respect to each other, so that the two films 101, 102 form an overlapping region 103. The fibre direction of the films 101, 102 preferably also extends at a right angle with respect to each other in order to achieve a particularly strong fibre reinforcement of the finished shell 100.

The regions 104, 105, 106, 107 of the films 101, 102 which project upwardly and downwardly or to the right and left of the overlapping region 103 are preferably formed in such a manner that at least one of the projecting regions 104, 106 of each film has the shape and surface dimensions of the overlapping region 103.

The product bag 108 with the connection 109 is placed onto the overlapping region 103 and preferably constitutes a non-pressure-proof inner bag, as described in detail in the exemplified embodiments above. Furthermore, when a product bag 108 is used with a combined connection 109, no further connection has to be used for the pressure bag, in this case the casing. Otherwise, at least one of the films can also have a corresponding pressure connection.

In order to achieve a securely closed casing or shell 100, initially the projecting regions 104, 105 of a film 101 are turned over onto the overlapping region 103, as shown in FIG. 14b, such that the product bag 108 is surrounded by the film 101. The projecting region 104 is first turned over and has the shape and surface dimensions of the overlapping region 103 and the second overlapping region 105 of the same film 101 is then placed onto the already turned-over region 104. The same procedure is carried out with the other film 102. By reason of the self-adhesive characteristics of the films 101, 102 or of the glue used, the respectively overlapping regions of the films 101, 102 adhere reliably to one another, so that a pressure-proof, collapsible shell 100 (like e.g. the aforementioned shells 2, 12, 22, 32) is produced, in which the product bag 108 is securely disposed. By virtue of the fact that one film 101 surrounds the non-pressure-proof inner bag 108 in the longitudinal direction and the other film 102 surrounds the non-pressure-proof inner bag 108 in the transverse direction, the shell 100 thus produced has a particularly high pressure resistance, so that it is able to reliably absorb the pressures which occur in the container arrangement in accordance with the invention.

In order also to ensure a certain movement and expansion of the inner bag 108 or product bag, the surfaces or regions 103, 104 of the films 101, 102, with which the product bag 108 is in contact, cannot be self-adhesive or cannot be provided with glue.

In order to ensure that the connection 109 of the product bag 108 is accessible from the outside, openings 110, 111 for guiding the connection 109 through are preferably provided preferably at corresponding locations in the films 101, 102 of the shell 100.

As shown in FIG. 14c, the shell 100 can optionally be surrounded on the outside by a film 112, e.g. a shrink film or a protective film welded to the edges. As a consequence, the friction on the self-adhesive or glued connection areas is increased and therefore the connection has greater strength.

FIGS. 15a and 15b illustrate a second embodiment of a shell 200. The shell 200 consists in this case preferably of two independent tubes 201, 202. The tubes consist preferably of fibre-reinforced, isotropic films.

Firstly, a first tube piece 201 is placed preferably in the longitudinal direction over a non-pressure-resistant inner bag 208 or product bag with a connection 209 (FIG. 15a). Then, a second tube piece 202 is placed preferably in the transverse direction over the non-pressure-proof inner bag 208 and the first tube piece 201 (FIG. 15b). The tube pieces 201, 202 seal one another by virtue of the fact that they are interleaved substantially at right angles with respect to each other, and the inner bag 208 is also rendered pressure-proof The compressive strength is thus provided both in the longitudinal direction and transverse direction.

In order to ensure that the connection 209 of the product bag 208 is accessible from the outside, openings 210 for guiding the connection 209 through are preferably provided preferably at corresponding locations in the tube pieces 201, 202 of the shell 200.

The construction can also preferably be provided, i.e. encased, with a film 212, such as e.g. a shrink film or a protective film welded to the edges, in order to achieve a certain contour accuracy of the bag. Likewise, the friction at the connection areas of the tube pieces is consequently increased and therefore the connection has greater strength.

FIGS. 16a to 16d illustrate a shell 300 consisting of woven fabric. The shell 300 consists preferably of two individual partial surfaces, a rear-side part 301 and a front-side part 302. The front-side part 302 preferably has essentially one base surface which corresponds to that of the product bag 308 (FIG. 16b). The rear-side part 301 preferably has at least the base surface 308 of the product bag 308 and also regions 304, 305, 306, 307 which project at the side edges (FIG. 16a).

As illustrated in FIG. 16c, the non-pressure-resistant inner bag 308 or product bag is preferably surrounded by the rear-side part 301 and by the front-side part 302 of the shell 300. The front-side part 302 and the rear-side part 301 of the shell 300 consisting of woven material are preferably placed onto one another such that they enclose the product bag 308 therebetween (FIG. 16c). Subsequently, the projecting regions 304, 305, 306, 307 of the rear-side part 301, which preferably form adhesion areas, are turned over onto the front-side part 302 and adhered thereto (FIG. 16d). This be accomplished by welding, the application of glue or by means of self-adhesive woven material.

At least one of the parts 302 of the shell 300 has preferably one opening 310 for guiding the connection 309 of the product bag 308 through, as has already been described above.

Preferably, the regions of the shell 300 which are in contact with the product bag 308 are not provided with glue or do not comprise any self-adhesive characteristics, in order to ensure a certain movement and expansion of the product bag 308.

Fundamental possibilities of joining the shell together will be demonstrated hereinafter. FIGS. 17a and 17b illustrate examples of the joining procedure performed using self-adhesive films, whereas FIGS. 18a and 18b illustrate examples of films being joined together by means of glue or adhesives or by welding.

FIG. 17a illustrates the joining procedure performed using self-adhesive, fibre-reinforced film or self-adhesive woven material 401. For this purpose, the film 410, as also illustrated in FIGS. 14a and 14b, is preferably turned over in each case from two sides, so that that the turned-over regions 401a, 401b overlap. By reason of the self-adhesive characteristics of the film 401, an adhesion area 402 is inevitably formed at the overlapping regions 401a, 401b, so that the shell is joined together in a secure manner. The surface of the adhesion area 402 conforms with the occurring maximum tensile forces.

FIG. 17b illustrates the shell being joined together by means of a self-adhesive, fibre-reinforced film or a woven material 411 and a further self-adhesive film piece or woven material piece 412. This film piece or woven material piece 412 is disposed in such a manner that its self-adhesive area is joined together with the self-adhesive area of the film 411. For this purpose, the film piece 412 is preferably disposed with its self-adhesive area away from the film 411, and the self-adhesive areas of the film 411 are turned over such that they come into contact with the self-adhesive areas of the film piece 412 and each form an adhesion area 413a, 413b. This affords the advantage of a much improved adhesive connection at the adhesion area 413a, 413b.

FIG. 18a illustrates the connection of a fibre-reinforced film or of the woven material 501 by means of an adhesive or by means of a weld at the adhesion area 502. The structure is comparable to that shown in FIG. 17a, except that in place of the self-adhesive film a glue or an adhesive is used or the overlapping regions 501a, 501b of the film 501 are welded.

FIG. 18b illustrates the connection of the shell consisting of two film pieces or two woven material pieces 511, 512. The structure of the shell corresponds substantially to that shown in FIG. 17b, but with the difference that the fibre-reinforced film piece or woven material piece 511 is connected by means of an adhesive or a weld at the adhesion area 513a, 513b to the second film piece or woven material piece 512.

The surfaces are thus connected preferably by means of broad-surface adhesion using glue or a self-adhesive surface or by welding. However, the required minimum adhesive surface or welding surface depends upon the desired compressive strength and the associated occurring maximum tensile forces and the position of the connection area and the quality of the connection.

With reference to FIGS. 19a to 19o, a method of joining together a container arrangement in accordance with the invention will be described hereinafter.

In order to produce the pressure bag, i.e. the casing or shell, any pressure-proof film can be used which will be described in greater detail hereinafter. As illustrated in FIG. 19a, e.g. a self-adhesive film 600 consisting of a fibre-reinforced film 601 and an adhesive layer 602, which is disposed preferably on only one side of the fibre-reinforced film 601, is used to produce the pressure bag, i.e. the shell.

In a first step, this film 600 with the adhesive layer 602 directed preferably towards the outside is placed preferably against a drum-shaped body 610 (FIG. 19a). The film 600 is held e.g. on a holding region 611 of the drum 610 preferably by means of a vacuum. However, any other form of holding arrangement, e.g. also a mechanical holding arrangement, is also feasible.

By virtue of a rotation of the drum 610, the film is then wound with an outwardly directed adhesive layer 602 in the longitudinal direction around the drum-shaped body 610 (FIG. 19b). The self-adhesive film 600 is wound around the drum-shaped body 610 until the end regions of the film 601 overlap at least partially. By reason of the adhesive layer 602, the overlapping regions of the film 601 thus adhere to one another, so that the self-adhesive film 600 is formed in a tubular manner (FIG. 19c).

With reference to FIGS. 19c and 19d, in a second step the drum-shaped body 610 is removed, i.e. it is drawn out of e.g. the tubular film 600. Since the adhesive layer 602 of the film 600 is preferably directed merely towards the outside, the film 600 does not adhere to the drum-shaped body 610.

For example, a rectangular body 620 is then introduced into the hollow body of the film 600, so that the rectangular body 620 is disposed preferably at least over the entire length of the tubular self-adhesive film 600 (FIG. 19d). If the rectangular body 620 is disposed in the film 600, it is preferably expanded in width (FIG. 19e) such that the film 600 is changed from the tube shape into a rectangular shape (FIG. 19f). It should be noted at this juncture that the body 620 can also have any other shape, depending upon which shape the pressure bag or shell is to have. For this purpose, correspondingly differently shaped bodies must then be used for shaping the film 600.

In order to produce e.g. a rectangular pressure bag 600, the following steps in FIGS. 19g to 19i can also be performed as an alternative to the steps in FIGS. 19a to 19f.

For this purpose, a rectangular body 630 is used instead of a drum-shaped body. The film 600 is placed against the rectangular body with the adhesive layer 602 directed preferably towards the outside, wherein it is also held e.g. on a holding region 631 of the body 630 by means of a vacuum (FIG. 19g).

By virtue of a rotation of the rectangular body 630, the film 600 is then wound with an outwardly directed adhesive layer 602 in the longitudinal direction around the rectangular body 630 (FIG. 19h). The self-adhesive film 600 is wound, in a manner comparable to that described above, around the rectangular body 630 until the end regions of the film 601 overlap at least partially, so that by reason of the adhesive layer 602 the overlapping regions of the film 601 adhere to one another. This produces, without any further intermediate steps, the desired rectangular shape of the pressure bag (FIG. 19i). It should also be noted at this juncture that the body 630 can have any other shape depending upon which shape of the pressure-proof shell of the container arrangement is desired.

Irrespective of which of the aforementioned method steps has been preformed, the film in accordance with the illustrated example now has a rectangular shape. For the purposes of stabilisation and shaping, the rectangular body 620, 630 preferably remains disposed in the film 600.

As shown in FIG. 19j, in a next step a further self-adhesive film 605, likewise comprising a fibre-reinforced film 606 and an adhesive layer 607 is applied with the adhesive layer 606 or adhesive side upwards on one side, e.g. an underside of the film 600, in the transverse direction. In this manner, the fibres of the fibre-reinforced films 601, 606 are preferably aligned substantially a right angles with each other, so that the compressive strength of the container arrangement is distributed substantially uniformly in all directions and is as great as possible.

FIG. 19k illustrates a view of the previously described arrangement which is rotated horizontally by 90°. It is apparent that at a later stage in the method, regions 608, 609 of the second film 605 which are still to be folded over project towards both sides from the underside of the first film 600 formed in an rectangular manner. A connection piece 603, preferably also consisting of a self-adhesive film with the adhesive side upwards, i.e. away from the first film 600, is applied to the topside, i.e. the side of the first film 600 lying opposite the second film 605.

Furthermore, the adhesive layer 607 of a first region 608 of the second film 605 to be folded over is covered by means of a non-adhesive cover 604, e.g. a non-adhesive film or paper. Likewise, an upper region of the first film 600 and of the connection piece 603 is covered with a non-adhesive cover 604 towards one side of the first region 608 to be folded over. This serves to prevent any inadvertent adhesion and contamination of the adhesive layers 602, 607 in the further steps, in which these regions are exposed towards the outside.

Subsequently, as shown in FIG. 19l, the second region 609 which is to be folded over and which is not provided with a non-adhesive film is folded over such that the second film 605 or the second region 609 is disposed with its adhesive layer 607 on the adhesive layer 602 of the first film 600 on its top side and the connection piece 603 which are not provided with the non-adhesive cover 604. In this manner, a first open end of the first film 600 is closed simultaneously.

Holes, i.e. lead-throughs 641, 642 for connections of an inner bag are then correspondingly punched into this arrangement or shell 640 in the films 600, 605. The rectangular body 620, 630 can serve at the same time as a die for the punching tools S. It should be noted that the holes can also be punched in a different method step or the films 600, 605 can even be provided with holes as they are being produced.

After the holes, i.e. the lead-throughs 641, 642, have been punched, the rectangular body 620, 630 is removed from the pressure shell 640 (FIG. 19m). For this purpose, it is preferably drawn out of the still remaining second opening in the shell 640. Since the first region 608 of the second film 605 is provided with the non-adhesive cover 604, the rectangular body 620, 630 is prevented from adhering to the first region 608 in this step.

The inner bag(s) 650 (depending upon the design) is/are then introduced preferably through the opening into the hollow pressure shell 640 which is open towards one side. As shown in FIG. 19n, this type of inner bag 650 has a product bag 651 and a pressure bag 652. The product bag 651 also preferably has a product connection 653, whereas the pressure bag 652 preferably has a pressure connection 654.

The bags 651, 652 are connected to one another on one side in each case preferably by means of a connection region 655. This connection region 655 is used preferably as an insertion aid for an insertion tool W for inserting the inner bag 650. For this purpose, the tool W preferably grasps behind the connection region 655 and pushes it into the shell. In so doing, the product bag 651 and the pressure bag 652 fold preferably in opposition to the direction of insertion against the tool W and can thus be introduced in a simple manner into the shell 640. The tool W then comes out of the shell 640.

As illustrated in FIG. 19o, the inner bag 650 is introduced into the pressure shell 640 in such a manner that the connections 653, 654 of the bags 651, 652 are inserted through the lead-throughs 641, 642 punched into the films 600, 605 and protrude out of same, so as to be accessible from the outside.

In a last step, as also illustrated in FIG. 19o, the non-adhesive covers 604 are removed from the films 600, 605 and the connection piece 603. The first region 608 of the second film 605 is then folded over such that its adhesive layer 607 is disposed on the not yet covered adhesive layer 602 of the first film 600 on its top side and of the connection piece 603. In this manner, the pressure shell 640 is completely closed and surrounds the inner bag 650 entirely. By virtue of the adhesive layers 602, 607 adhering one on top of the other and the mutually transversely disposed fibres of the fibre-reinforced films 600, 605, a heavy duty, pressure-proof shell 640 is produced for the non-pressure-proof inner bag 650 of the container arrangement in accordance with the invention.

The advantages of the aforementioned method of producing a container arrangement in accordance with the invention reside on the one hand in the fact that the pressure casing or pressure shell is joined together in such a manner that the entire outer skin is joined together on an adhesive layer to adhesive layer basis. Therefore, at all areas, where high tensile forces occur, adhesive surface is joined to adhesive surface and/or a reliable connection is established by high friction. This ensures a high degree of compressive strength in the container arrangement, in order to reliably absorb the pressures occurring in the container arrangement. This is also abetted by the mutually transversely aligned fibres of the fibre-reinforced films.

On the other hand, a bag which is produced in this manner is accurate to shape and does not have to be surrounded by an additional protective film, such as e.g. a shrink film.

Furthermore, since the inner side of the pressure shell is non-adhesive, i.e. it does not have any adhesive layer or the like, it is thus also not necessary in addition to cover it with a non-adhesive film

Therefore, it is also possible for the entire method, i.e. the production of the pressure casing and the insertion of the inner bag(s) to be performed in a fully automated manner. In this manner, the bags can be manufactured particularly quickly and cheaply in large quantities. For this purpose, particularly the inner bag can also be produced entirely on currently conventional bag machines.

The invention is not limited to the aforementioned restrictions. It should be noted once again that e.g. the shell can surround the non-pressure-proof inner bag or container as a separate part or it can be an integral part thereof. Moreover, in terms of its size and shape the container arrangement is not limited by the exemplified embodiments. The production of the bags or pressure shell is also not limited to the aforementioned exemplary methods. Furthermore, all feasible materials can also be used for the casing and bag. Particularly preferred materials are described hereinafter.

For outer walls and intermediate walls which are not or do not have to be pressure-resistant, preferably suitable films include those consisting of polyethylene (PE) in its various forms, such as e.g. low density polyethylene (LDPE), linear low density polyethylene (LLDPE), medium density (MDPE) and high density polyethylene (HDPE) and films consisting of ethylene vinyl alcohol copolymer (EVA or EVOH), nylon, PP, PET or PVC. They can be single films or composite films, laminated films, co-extruded films or metallised films. The structure of the film conforms with the characteristics of the product and is selected so as to ensure e.g. optimum quality and shelf life of the product. In the case of beer, e g a film is selected which is food-safe and has a maximum barrier function against gases, such as in particular CO₂ and O₂, and against light.

Films suitable as the pressure shell or as an independent pressure bag are preferably gas-tight and pressure-proof films, e.g. stretched synthetic material films, composite films, laminated or co-extruded films, such as e.g. the aforementioned, non-pressure-resistant films which are additionally reinforced by woven materials consisting of synthetic material, synthetic fibres, glass fibres, carbon fibres or natural fibres.

For non-gas-tight pressure shells, it is possible to use films, strips, coated or uncoated woven materials which consist of mineral or synthetic fibres, such as e.g. glass fibres, carbon fibres etc. or are reinforced thereby.

Furthermore, in to reduce costs and weight, the fibre density (number of fibres/cm²) can be arranged such that the tensile forces which occur at different strengths at different locations can be absorbed in an optimum manner.

Woven synthetic material or grid films (e.g. consisting of PVC, PET) or woven material consisting of natural fibres are preferably suitable as conditionally pressure-proof and conditionally gas-tight films.

Woven materials, e.g. consisting of synthetic materials fibres, natural fibres, carbon fibres or glass fibres are suitable as a pressure-proof, non-gas-tight shell.

### LIST OF REFERENCE NUMERALS

1, 10, 20, 30 container arrangement
2, 12, 22, 32 casing, shell
3, 13, 23, 33 first chamber, product chamber
4, 14, 24, 34 second chamber, pressure chamber
5, 15, 25, 35 first connection, product connection
6, 16, 26, 36 second connection, pressure connection
7, 17, 27, 37 wall
8, 18, 28, 38 product bag or container
9, 19, 29, 39 pressure bag or container
21, 31 bag
40, 50, 60 container arrangement in the shape of a pad
61 combined connection
45, 55, 65 product connection
46, 56, 66 pressure connection
70 container arrangement in a cylindrical shape
80 container arrangement in a cubic shape
90 container arrangement connected in parallel
91 pressure line
92 product line
100 shell or casing
101 first film
102 second film
103 overlapping region
104, 105, 106, 107 projecting region
108 product bag or container
109 connection
110 first opening
111 second opening
112 film surrounding the container arrangement
200 shell or casing
201 first stirring piece [sic]
202 second tube piece
208 product bag or container
209 connection
210 opening
212 film surrounding the container arrangement
300 shell or casing
301 rear-side part
302 front-side part
304, 305, 306, 307 projecting regions
308 product bag or container
309 connection
310 opening
401 self-adhesive film or woven material
401a, 401b turned-over regions
402 adhesion area
411 self-adhesive film or woven material
412 self-adhesive film or woven material piece
413a, 413b adhesion area
501 film or woven material
501a, 501b overlapping regions
502 adhesion area
511 first film or woven material piece
512 second film or woven material piece
513a, 513b adhesion area
600, 605 self-adhesive film
601, 606 fibre-reinforced film
602, 607 adhesive layer, adhesive side
603 connection piece
604 non-adhesive cover
608, 609 region to be folded over
610 drum-shaped body
611, 631 holding region
620, 630 rectangular body
640 pressure shell
641, 642 lead-throughs
650 inner bag
651 product bag
652 pressure bag
653 product connection
654 pressure connection
655 connection region
H handle
S punching tool
W insertion tool

1. A method of transporting and dispensing gas-containing liquids into or out of a pressure-proof, collapsible casing (2, 12, 22, 32), comprising the steps of:
filling a first chamber (3, 13, 23, 33) with the gas-containing liquid via a first connection (5, 15, 25, 35),
subjecting a second chamber (4, 14, 24, 34), which is connected to the first chamber (3, 13, 23, 33) via a flexible wall (7, 17, 27, 37), to a pressure by introducing a fluid medium via a second connection (6, 16, 26, 36) of the second chamber (4, 14, 24, 34),
increasing the volume of the second chamber (4, 14, 24, 34) and thus exerting a pressure from the second chamber (4, 14, 24, 34) upon the first chamber (3, 13, 23, 33) via the flexible wall (7, 17, 27, 37),
dispensing the gas-containing liquid via the first connection (5, 15, 25, 35) by reducing the volume of the first chamber (3, 13, 23, 33).

2. A container arrangement for gas-containing liquids, comprising a casing, wherein the casing consists of a pressure-proof, collapsible material, and the casing surrounds at least two chambers, wherein the first chamber (3, 13, 23, 33) is used for receiving and dispensing the gas-containing liquid via a first connection, the second chamber (4, 14, 24, 34) is a pressure chamber which is provided with a second connection for the application of pressure, and a flexible wall is disposed between the first chamber (3, 13, 23, 33) and the second chamber (4, 14, 24, 34).

3. The container arrangement as claimed in claim 2, wherein the second chamber (4) surrounds the first chamber (3) completely and the wall (7) is formed by a sheath of the first chamber (3).

4. The container arrangement as claimed in claim 2, wherein the casing (2) is formed from a pressure-proof outer wall of the second chamber (4).

5. The container arrangement as claimed in claim 2, wherein the first chamber (13, 23, 33) and the second chamber (14, 24, 34) are disposed next to one another in the casing (12, 22, 32).

6. The container arrangement as claimed in claim 5, wherein the first chamber (13) and the second chamber (14) are formed as separate soft-walled bags (18, 19).

7. The container arrangement as claimed in claim 6, wherein the wall (17) is formed from the adjoining wall regions of the first chamber (13) and the second chamber (14).

8. The container arrangement as claimed in claim 5, wherein the first chamber (23, 33) and the second chamber (24, 34) are formed from a bag (21, 31), wherein the wall (27, 37) is formed integrally with the bag (21, 31) between the chambers (23, 24).

9. The container arrangement as claimed in claim 8, wherein the pressure-proof casing (22) surrounds the bag (21) completely.

10. The container arrangement as claimed in claim 8, wherein the bag (31) forms the pressure-proof casing (32).

11. The container arrangement as claimed in claim 2, wherein the container arrangement (40, 50, 60, 70, 80) has a pad shape or cylindrical shape or cubic shape.

12. The container arrangement as claimed in claim 2, wherein the container arrangement has handles (H).

13. A pressure-proof, flexible, non-expandable or only slightly expandable shell, in particular for a container arrangement as claimed in claim 2, wherein the shell (2, 12, 22, 32, 100, 200, 300) consists of a film (101, 102, 201, 202, 301, 302, 401, 411, 412, 501, 511, 512) which is reinforced by mineral or synthetic fibres in the longitudinal or transverse direction or in the longitudinal and transverse direction or consists of a woven material which is produced from synthetic fibres or is reinforced by such fibres.

14. The pressure-proof, flexible, non-expandable or only slightly expandable shell as claimed in claim 13, wherein the shell (2, 12, 22, 32, 100, 200, 300) can in principle surround all non-pressure-proof bags or containers (8, 18, 19, 21, 28, 29, 108, 208, 308) such that they become pressure-proof.

15. The pressure-proof, flexible, non-expandable or only slightly expandable shell as claimed in claim 14, wherein the shell (2, 12, 22, 32, 100, 200, 300) is a separate or integral part of the bag or container (8, 18, 19, 21, 28, 29, 108, 208, 308) rendered pressure-proof in this manner.

16. The pressure-proof, flexible, non-expandable or only slightly expandable shell as claimed in claim 13, wherein the shell (2, 12, 22, 32, 100, 200, 300) is joined together by means of self-adhesive film or self-adhesive woven material or by gluing or welding.

17. The pressure-proof, flexible, non-expandable or only slightly expandable shell as claimed in claim 1, wherein the surfaces or regions of the films (101, 102, 201, 202, 301, 302, 401, 411, 412, 501, 511, 512), with which the bag or container (8, 18, 19, 21, 28, 29, 108, 208, 308) is in contact, are not self-adhesive or are not provided with glue.

18. The pressure-proof, flexible, non-expandable or only slightly expandable shell as claimed in claim 13, wherein the fibre reinforcement of the film or the structure or the reinforcement of the woven material can be optimised by specific local adaptation of the fibre density per unit of area.

19. The pressure-proof, flexible, non-expandable or only slightly expandable shell as claimed in claim 13, wherein the shell (100, 200) is surrounded on the outside by a further film (112, 212).
